(19) United States
(12) Patent Application Publication
(10) Pub. No.: US 2009/0132067 A1
(43) Pub. Date: May 21, 2009

(54) Design Device for Designing a Control System and Method for Examining the Technological Aims When Designing a Control System

(76) Inventors: Alfred Degen, Erlangen (DE); Franz Deutel, Bubenreuth (DE); Horst Fischer, Nurnberg (DE); Hans-Dieter Humpert, Hemhofen (DE); Horst Jackisch, Furth (DE); Dieter Kleyer, Herzogenaurach (DE); Gunter Schmidt, Nurnberg (DE); Wilhelm Schultze, Erlangen (DE); Christian Spiska, Schulstr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/887,858

(22) PCT Filed: Mar. 31, 2006
(86) PCT No.: PCT/EP2006/061221

§ 371 Date: Feb. 6, 2009

(30) Foreign Application Priority Data
Apr. 5, 2005 (EP) 05007417.8

(51) Int. Cl. G05B 15/02; G06G 7/66

(52) U.S. Cl. 700/83; 700/86; 703/13

(57) ABSTRACT

The invention relates to a developer device for designing a control system comprising automation software and automation hardware for the automatic operation of a process. The designing device comprises a design module which is embodied in order to design the automatic software, an engineering module which is connected to the design module in order to receive the automation software, and which is configured in order to project the automation hardware based on the automation software and to produce projection data on the automation hardware, and a simulation module for simulating the automation software and the processes, and which is connected to the engineering module which is used to receive the projection data, in addition to the design module which is used to transfer simulated process data.

### CROSS REFERENCE TO RELATED APPLICATIONS

This application is the US National Stage of International Application No. PCT/EP2006/061221, filed Mar. 31, 2006 and claims the benefit thereof. The International Application claims the benefits of European application No. 05007417.8 filed Apr. 5, 2005, both of the applications are incorporated by reference herein in their entirety.

### FIELD OF INVENTION

The present invention relates to a design device for designing a control system comprising automation software and hardware for the automated operation of a process. Furthermore, the invention relates to a method for examining the technological aims when designing a control system in the presence of automation software in a design module.

### BACKGROUND OF THE INVENTION

During the course of the processing of control systems, the processors can experience faults at any stage of the processing. Faults can occur during clarification of the aims, the design phase, the configuration or during commissioning (EBS).

When creating and commissioning control systems, in particular in power station control technology, it generally applies that outlay for fault repair is significantly lower at an earlier stage of the processing than at a later stage. It essentially applies that the earlier a fault is identified and repaired, the lower the costs for the fault clearance. Repairing a fault is particularly complicated if the fault is first recognized during operation of the system. Shutdown and production failure thus result. Failure costs of up to £100.000 per hour can then occur in the field of power plants.

With the definition of the technological aims for control systems, there was previously no possibility of recognizing faults in the aims and of ensuring the accuracy of the aims. It was hitherto not possible to ensure the function and completeness of the defined aims. Continuous methods based on data processing are not available. The aim was previously either formulated “on paper” or with the aid of insulated CAD methods (CAD: Computer Aided Design). Faults, which occur in this phase, cannot be recognized immediately, but are discovered at a later stage of the processing of a control system or even when the control system is initially commissioned with the aid of complicated tests.

In the later stage of the processing of a control system, the automation is already realized completely. Automation is understood here to mean automation software and hardware for the automated operation of a process, a gas turbine process for instance. The effort needed to repair the fault increases as a function of the processing phase, in which the control system is disposed during fault clearance in automation. In particular, if the fault is first to be repaired during the method-specific commissioning, which represents the latest phase of the processing of the control system, the correction of a fault in the automation is associated with a great outlay, since at this time, both hardware and also software were already completed on the basis of the original aims and examined.

### SUMMARY OF INVENTION

The object of the present invention is thus to provide a device and a method with which faults in the automation of a control system can be detected as early as possible.

Said object is achieved by a developer device as well as by a method as claimed in the claims. The dependent claims contain advantageous embodiments of the developer device according to the invention and/or of the method according to the invention.

A design device according to the invention for designing a control system comprising automation software and hardware for the automated operation of a process includes:
a design module configured to design the automation software,
an engineering module connected to the design module in order to receive the automation software, said engineering module being designed to configure the automation hardware on the basis of the automation software and to produce configuration data on the automation hardware, and
a simulation module designed to simulate the automation hardware and process and connected to the engineering module in order to receive the configuration data as well as to the design module in order to transfer simulated process data.

Within the scope of this description, configuration is understood to include not only configuring, but also parameterizing and programming the automation hardware on the basis of the automation software.

The design module can include a technology plan design module, which is configured to design a technology plan, i.e. to design an overview plan, which advantageously graphically represents both the method-specific components as well as the control components. The technology plan design module is connected to a converter which is configured to convert the technology plan into the automation software which is specific for the control system to be designed and to produce the automation software on the engineering module, which generates in particular the program code for the automation hardware. The converter can be an independent unit or a converter module integrated into the design module.

In particular, as a system-specific automation software the converter is able to generate so-called function plans of the individual plane, which are specific for the control system to be designed and represent individual sequences of the automation software. The engineering module then generates the program code for the automation hardware from the preferably graphically represented individual sequences in the function plans of the individual plane.

In the design device according to the invention, the simulation module can either be directly or indirectly connected to the design module for transferring simulated process data, by way of the engineering module for instance.

The design device according to the invention enables a narrow coupling of a design module to design automation software or technology plans using a process simulator. This thereby enables the correctness and completeness to be examined in the definition phase of the technological aims. The integration of the simulator consequently enables the selected technology plan to examine whether this functions in the desired manner.

By virtue of implementing a simulation already on the basis of the automation software or preferably on the basis of the technology plan, the impact of faults on the technological process can be immediately recognized and subsequently immediately repaired. Even absent measuring facilities and actuators in the control system, which are necessary for the process automation, can be immediately recognized using the simulation. This enables corrections to be initiated promptly.

The result of examining an automation software or a technology plan using the simulation can be shown in the design module. In particular, while examining a technology plan, a recognized fault can then be immediately repaired by correcting the technology plan and not as hitherto, only iteratively at later stages, when the automation software and in some instances even the automation hardware are completely realized. This prompt correction improves the quality of the configuration results. Costs can be lowered and the processing time during the system processing can be reduced on the basis of a shortened test phase. In addition, the risk of faults during operation can be minimized.

In an advantageous development of the design device, the design module includes a graphical interface and a graphical display unit for displaying the simulated process data. The graphical display unit and the graphical interface even allow complex structures to be depicted. In addition, the impacts of the control function on the process can be clarified graphically.

The design module can be connected to the simulation module in order to receive the simulated process data by way of an interface, in particular by way of an interface based on a database. In this way the coupling between the simulation module and the design module can, to a large extent, be carried out automatically.

In a further advantageous embodiment of the design device according to the invention, said design device includes a memory for storing simulated process data received by the design module. The storing of simulated process data enables the continuous use of process data received by the design module across all phases of the configuration and the commissioning to the point of operation of the control system. This ensures the consistency of the simulated data during the whole process. The examined quality of the aims can thus be adopted in all phases of the realization of the control system.

The method according to the invention for examining the technological aims when designing a control system in the presence of an automation system in a design module includes the steps:
Creating or calling-up a simulation environment, which simulates the automation hardware belonging to the automation software as well as the process to be controlled,
Emulating the automation software in the simulation environment in order to generate simulated process data and
Displaying the simulated process data in the design module.

The method according to the invention allows the technological aims for the control system to be examined already at an early point in time in the development process.

An examination of the technological aims at a particularly early design stage is possible if the automation software is still at the stage of a technology plan, while examining the technological aims, and the method includes a step of converting the technology plan into the specific automation software. In particular, the technology plan can be converted into a number of function plans of the individual plane, which represent the system-specific automation software.

In order also to depict complex structures, the simulated process data can be graphically displayed.

In an advantageous development of the method according to the invention, which enables a continuous use of the detected process data across all phases of the configuration and the commissioning of a control system, the simulated process data is stored.

All in all the method offers said advantages in respect of the developer device.

### BRIEF DESCRIPTION OF THE DRAWINGS

Further features, characteristics and advantages of the present invention result from the description below of exemplary embodiments with reference to the appended figures, in which;

FIG. 1 shows a first exemplary embodiment for a developer device according to the invention in the form of a block diagram.

FIG. 2 shows a second exemplary embodiment for a developer device according to the invention in the form of a block diagram.

### DETAILED DESCRIPTION OF INVENTION

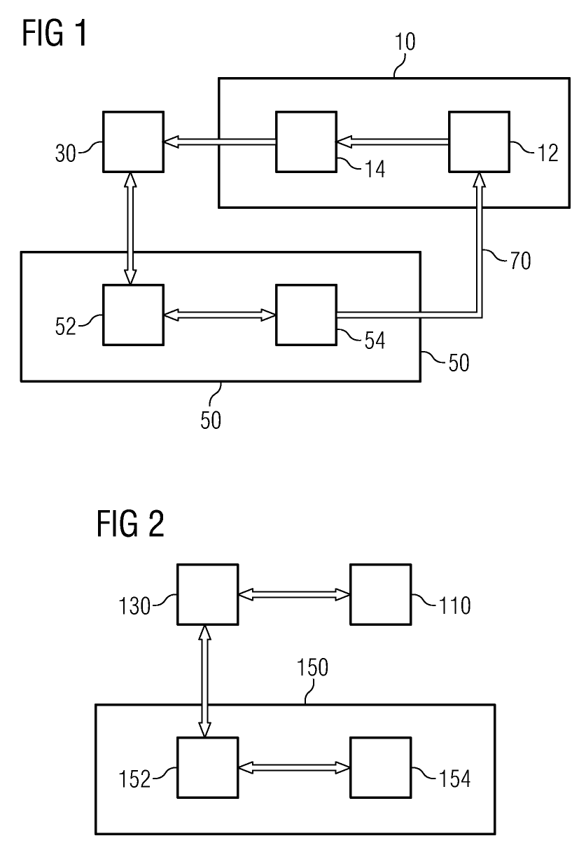

A first exemplary embodiment for the developer device according to the invention is shown in FIG. 1 in the form of a block diagram. The device includes a design module 10 for designing the automation software for a control system comprising automation hardware. In addition, it includes an engineering module 30 connected to the design module 10 for receiving the automation software, said engineering module 30 being designed not only to configure, but to parameterize and program the automation hardware on the basis of the automation software. The developer device finally includes a simulation module 50, which is configured to simulate both the automation hardware as well as the process to be controlled.

In the present exemplary embodiment, the design module 10 is a technology editor, which provides a continuous connection between the control technology and the system. This includes two components, namely a technology plan design module 12, which provides the developer with a specific technological functionality, which is independent of the automation hardware, for which an automation software is to be developed. The developer can thus create technology plans for the system from a purely technological perspective, without being a specialist in the automation system, for which the software is to be produced. The technology editor 12 can be based on Microsoft standard components (VISIO) for instance and provides an extremely flexible tool with a high functionality, which can also be designed with an intuitive interface so that it can be operated easily and without any specialist knowledge.

The conversion of the non-specific technology plan into an automation software which is specific for the selected automation hardware is carried out in a converter 14 which is connected to the technology editor 12. In the present exemplary embodiment, the converter 14 is configured as a so-called function plan generator, which generates a number of function plans of the individual plane from the technology plan. These represent individual sequences of the user-specific automation software in a graphical display.

The design module 10 is connected to the engineering module 20, which already represents a part of the automation system, by way of the converter 14. The engineering module 30 receives the specific automation software from the converter 14 and generates the individual sequences of the program code of the control technology from the function plans of the individual plane. The automation hardware can be configured, parameterized and programmed with the aid of the engineering module 30.

Aside from the converter 14 of the design module 10, the engineering module 30 is also connected to the simulation module 50. In the developer device according to the invention, instead of the real automation hardware, simulated automation hardware is configured on the basis of the automation software.

In order to simulate the automation hardware, the simulation module 50 includes a hardware simulation module 52, which is connected to the developer module 30 in order to receive the configuration data. In addition, the simulation module 50 includes a process simulation module 54, which is connected to the hardware simulation module 52 and is used to simulate the process to be controlled. Both the hardware simulation module 52 and the process simulation module 54 can be realized both in the form of hardware and in the form of software.

The simulation module 50 generally accompanies the automation system during the overall life cycle. In addition to system design, it is also used with system tests and to train operating personnel.

The Simulation Based Engineering which is possible by way of the simulation module 50 enables the automation software to be tested at a point in time when no automation hardware is available or configured yet. In this way, the automation software is emulated in a manner similar to that of the process in the simulation module 50, i.e. the program code of the automation software created for the automation hardware is run in a simulated environment, preferably in a software environment.

In order to create process models for the process simulation, the simulation module 50 can provide an operator interface, with which process models can be created with the aid of branch-specific libraries. In addition, a memory can be available (not shown), in which once created process models can be stored. If the components of a process model can be parameterized, a simple adjustment of the process can also take place by means of suitably selecting the parameter.

The process simulation module 54 is connected to the technology plan design module 12 of the design module 10 in order to produce process data by way of a data bus 70. The process data in the technology plan design module 12 can be shown in this way.

In order to test the technology plan, said technology plan is forwarded to the converter 14, which converts it into a function plan which is specific for the engineering module 30, which already represents a part of the specific automation system, in other words into the specific automation software. The converter 14 then produces the automation software on the engineering module 30, which subsequently configures the automation hardware simulated in the hardware simulation module 52 on the basis of the received automation software. With the automation hardware configured in the hardware simulation module 52, the process simulated in the process simulation module 54 is run. The process data resulting from this simulation is then forwarded to the technology plan design module 12 by way of the data bus 70, where it is represented for instance by means of a graphical interface together with the technology plan. In this way, the developer is already able to test his/her technology plan at a very early stage and, if necessary, to carry out changes to the technology plan on the basis of the test, before configuring the real automation hardware.

The narrow interaction between the design module 10 and the simulation module 50 supplies a platform, which enables the technologists to test the creation of control and automation plans in a closed loop in a simple manner. The coupling between the design module 10 and the simulation module 50 is carried out in the present exemplary embodiment by means of an interface based on a database.

A second exemplary embodiment for the developer device according to the invention is shown in FIG. 2. The exemplary embodiment illustrated in FIG. 2 differs from the exemplary embodiment illustrated in FIG. 1 in that the design module 110 does not comprise any technology plan developer module and no converter. Instead, it is designed to develop an automation software which is already specific for the automation system. In some circumstances, this may be advantageous for a developer who is experienced in the development of software for a specific automation hardware. The system-specific software designed with the design module 110 can then be produced on the engineering module 130 without interconnecting a converter. The engineering module 130 of the second exemplary embodiment does not differ from the engineering module 30 of the first exemplary embodiment.

The simulation module 150 of the second exemplary embodiment differs from the simulation module 50 of the first exemplary embodiment in that it does not feature any direct connection with the design module 110. In the second exemplary embodiment, the process data produced by the process simulator 154 is thus produced on the design module 110 by way of the hardware simulation module 152 and the engineering module 130.

The developer system according to the invention can already be integrated into the control technology system at a time when automation hardware is still not available. This enables complete, consistent and examined aims, in terms of their function, to be achieved for the control technology, the structure and configuration data of which is continuous and can be automatically adopted in all development phases up to the point of commissioning and the actual operation.

The developer device according to the invention additionally enables an offline analysis of the system design at each stage of the design and operation of the system. The customer and contractor can thus introduce controlled changes at any time and monitor their realizability. Evidence of change and of additional applications can be carried out in a controlled and undisputed manner respectively. In addition, evidence of the overall functionality of the selected automation solution can be produced.

1.-8. (canceled)

9. A developer device for designing a control system comprising automation software and hardware for the automated operation of a process, comprising:
a design module having a technology plan design module to design a technology plan and a converter connected to the technology plan design module to receive the technology plan, the converter is configured to convert technology plans into specific automation software for the control system to be designed and to output the automation software;
an engineering module connected to the design module for receiving the automation software, the engineering module configures the automation hardware based on the automation software and produces a configuration data on the automation hardware, and
a simulation module that simulates the automation hardware and process and connected to:
the engineering module to receive the configuration data and
the design module for transmitting a simulated process data, with the design module connected to the simulation module to receive the simulated process data via an interface.

10. The developer device as claimed in claim 9, wherein the design module includes a graphical interface and a graphical display unit for displaying the simulated process data.

11. The developer device as claimed in claim 10, wherein the interface is based on a database.

12. The developer device as claimed in claim 11, wherein a memory is available for storing simulated process data received by the design module.

13. A method for examining the technological aims when designing a control system in the presence of automation software in a design module, comprising:
creating or calling-up a simulation environment, which simulates the automation hardware belonging to the automation software and the process to be controlled;
emulating the automation software in the simulation environment to generate simulated process data; and
displaying the simulated process data in the design module, wherein the automation software in the design module present in the form of a technology plan and in which a conversion of the technology plan into an automation software specific for the control system occurs prior to emulation.

14. The method as claimed in claim 13, wherein the technology plan is converted into a plurality of function plans, that represent system-specific automation software.

15. The method as claimed in claim 14, wherein the simulated process data is graphically displayed.

16. The method as claimed in claim 15, wherein the simulated process data is stored.
